(19) United States
(12) Patent Application Publication
(10) Pub. No.: US 2025/0296070 A1
(43) Pub. Date: Sep. 25, 2025

(54) ACID GAS CAPTURE THROUGH METAL-LIGAND INSERTION IN POROUS MATERIALS AT ELEVATED TEMPERATURES

(71) Applicant: THE REGENTS OF THE UNIVERSITY OF CALIFORNIA, Oakland, CA (US)

(72) Inventors: Jeffrey R. Long, Lafayette, CA (US); Kurtis Mickel Carsch, Berkeley, CA (US); Rachel C. Rohde, Berkeley, CA (US)

(73) Assignee: THE REGENTS OF THE UNIVERSITY OF CALIFORNIA, Oakland, CA (US)

(21) Appl. No.: 19/223,453

(22) Filed: May 30, 2025

Related U.S. Application Data
(63) Continuation of application No. PCT/US2023/086558, filed on Dec. 29, 2023.
(60) Provisional application No. 63/477,976, filed on Dec. 30, 2022.

(51) Int. Cl. B01J 20/22; B01D 53/04; B01J 20/34; C01B 3/16; C07F 3/06

(52) U.S. Cl. CPC B01J 20/226; B01D 53/04; B01J 20/3425; B01J 20/3491; C01B 3/16; C07F 3/06; B01D 2253/204; B01D 2257/504; B01D 2258/0233; B01D 2258/025; B01D 2259/40083; C01B 2203/0283; C01B 2203/0425; C01B 2203/0475

(57) ABSTRACT

Metal organic framework compositions and methods for acid gas capture from elevated temperature (70 to 370° C.) gas streams like those found in steel and cement manufacturing processes that require energy-intensive cooling prior to feasible CO₂ capture are disclosed. The metal-hydride frameworks ZnH-MFU-4l (Zn₅H₄(btdd)₃; H₂btdd=bis(1H-1,2,3-triazolo[4,5-b],[4′,5′-i])dibenzo[1,4]dioxin)) and ZnH-CFA-1 (Zn₅H₄(bibta)₃, where ZnH-CFA-1=Zn₅H₄(bibta)₃; H₂(bibta)=1H,1′H-5,5′-bibenzo[d][1,2,3]triazole demonstrate steep CO₂ uptake between 150° C. and 300° C. at low partial pressures, indicating strong sorbent-interactions with the framework through a metal-ligand insertion process.

### CROSS-REFERENCE TO RELATED APPLICATIONS

This application claims priority to, and is a 35 U.S.C. § 111(a) continuation of, PCT international application number PCT/US2023/086558 filed on Dec. 29, 2023, incorporated herein by reference in its entirety, which claims priority to, and the benefit of, U.S. provisional patent application Ser. No. 63/477,976 filed on Dec. 30, 2022, incorporated herein by reference in its entirety. Priority is claimed to each of the foregoing applications.

The above-referenced PCT international application was published as PCT International Publication No. WO 2024/145655 A2 on Jul. 4, 2024, which publication is incorporated herein by reference in its entirety.

### STATEMENT REGARDING FEDERALLY SPONSORED RESEARCH OR DEVELOPMENT

This invention was made with Government support under grant number DE-SC0019992, awarded by The Department of Energy. The Government has certain rights in the invention.

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

This technology pertains generally to methods and compositions for acid gas separations and capture and more particularly to the metal-organic frameworks M-X-MFU-4l and M-X-CFA-1 that demonstrate a high affinity for CO₂, SO₂ and NO₂ at temperatures far greater than other permanently porous materials, and uptake is entirely reversible with the application of a vacuum.

### 2. Background Discussion

Carbon dioxide (CO₂) emissions from fossil fuel combustion and other industrial processes account for an estimated 65% of greenhouse gas emissions from human activities and have significantly contributed to the estimated increase of 0.8° C. to 1.2° C. in global temperature since the pre-industrial era. Carbon capture and sequestration is widely regarded as a vital technology imperative in mitigating the effects of anthropologically generated climate change. Nonetheless, decarbonization of certain industrial sectors remains challenging. For instance, steelmaking and cement manufacturing industries combined account for approximately 10% of global carbon emissions per annum, in which associated waste streams are released at high temperatures exceeding 200° C. Capturing CO₂ from such high-temperature, high-carbon content streams with the state-of-the-art adsorbents requires extensive energy and capital expenditures to cool these effluent streams to the necessary working temperatures for efficient capture by these adsorbents.

In addition, many important carbon-containing industrial processes, such as the water-gas shift reaction, occur at elevated temperatures that preclude the use of conventional adsorbents. Sorption enhancement of this reaction, where CO₂ is captured by an appropriate material at the catalyst bed at temperatures exceeding 200° C., would promote greater production of hydrogen. Motivated by these applications, a generalizable mechanism for the capture of CO₂ and potentially other acidic gases at elevated temperatures is needed through metal-ligand insertion within modular and thermally robust metal-organic frameworks (MOFs).

Reducing carbon emissions from these industries remains challenging because many of these industrial processes such as steel and cement making, as well as important chemical reactions such as the water-gas shift reactions, occur at high temperatures and produce a hot, carbon-concentrated effluents. Accordingly, there is a need for gas capture compositions and methods that can function effectively and efficiently at high temperatures so that energy-intensive cooling can be avoided.

### BRIEF SUMMARY

Methods and compositions are provided for acid gas capture at higher temperatures in the range of those of typical gaseous effluents. Although numerous porous materials exist to capture CO₂ at point sources, no material has been reported that can adsorb gases at temperatures relevant for steel and cement manufacturing processes or for application in an adsorption-enhanced water-gas shift reactors, for example.

Porous framework materials, ZnH-MFU-4l and a new material ZnH-CFA-1 are illustrated along with a general approach towards high-temperature CO₂ capture via metal-ligand insertion into the metal-organic frameworks. In particular, the metal-organic framework ZnH-MFU-4l demonstrates a high affinity for CO₂ at temperatures far higher than other permanently porous materials, and CO₂ uptake is entirely reversible by the application of a vacuum or decrease in partial pressure of CO₂ without the obligatory reduction in temperature. The material is stable to over 500 isothermal CO₂ cycles at 300° C., and its high porosity enables fast adsorption and desorption kinetics and enhanced cyclability relative to more mature high-temperature CO₂ capture materials such as metal oxides. The ZnH-MFU-4l and the ZnH-CFA-1 materials represent highly modular platforms for acid gas capture and this new metal-hydride insertion mechanism is broadly tunable and generalizable to a host of other metal-organic framework types, as well as to the capture of other acid gasses of concern such as SO₂ and NO₂.

Synthesis methods for the ZnH-MFU-4l and the ZnH-CFA-1 materials are also provided that demonstrate a general high temperature insertion mechanism for high-temperature acid gas capture. In one embodiment, a new synthesis method to increase the active binding sites within the ZnH-MFU-4l material is provided.

The ZnH-MFU-4l materials are used to illustrate a larger group of materials comprising a metal-organic framework M-X-MFU-4l, where M=Zn, Mg, Ca, Mn, Fe, Co, Ni, Cu, Al, Cd and Zr including mixtures of these metals within the same framework, and X denotes an anionic terminal ligand such as hydride (H⁻), and MH-MFU-4l=M₅Hₓ(btdd)₃; H₂(btdd)=bis(1H-1,2,3-triazolo[4,5-b],[4′,5′-i])dibenzo[1,4]dioxin) and x=1-12.

Likewise, the ZnH-CFA-1 metal-organic framework is used to illustrate the group of frameworks MX-CFA-1, where M=Zn, Mg, Ca, Mn, Fe, Co, Ni, Cu, Al, Cd and Zr including mixtures of these metals within the same framework, and X denotes an anionic terminal ligand such as hydride (H⁻) and MH-CFA-1=(M₅Hₓ(bibta)₃ where H₂(bibta)=1H,1′H-5,5′-bibenzo[d][1,2,3]triazole and x=1-12.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a schematic crystal structure of the metal-organic framework ZnH-MFU-4l parent framework with pentanuclear cluster node depicted for clarity.

FIG. 2A-2B is a synthetic procedure shown schematically that was developed to exchange terminal capping chloride ligands for formate anions. Carbon dioxide adsorption is accomplished through thermolysis at 300° C. under vacuum, accompanied by conversion of Zn(OCHO)-MFU-4l to ZnH-MFU-4l in quantitative yield.

FIG. 3 is a schematic depiction of CO₂ gas adsorption of the ZnH-MFU-4l framework.

FIG. 4 is a plot of single component CO₂ isotherms conducted on ZnH-MFU-4l between 150° C. and 300° C. showing gas adsorption performance of the ZnH-MFU-4l framework material. Open circles correspond to desorption points.

FIG. 5A is a plot of adsorption over time of 50% CO₂/Ar, 25% CO₂, 10% CO₂ and 5% CO₂ sources demonstrating fast kinetics.

FIG. 5B is a plot of desorption over time at different temperatures.

FIG. 6 is a plot of time-dependent infrared (IR) spectra of ZnH-MFU-4l upon dosing with 200 mbar of CO₂ at 210° C. Spectral changes cease within five minutes following CO₂ dosing, revealing rapid saturation kinetics.

FIG. 7 is a plot of IR spectra of ZnH-MFU-4l reacting with isotopically labeled ¹³CO₂ reveals characteristic formate stretches at 1613 cm⁻¹ and 1304 cm⁻¹ and a formate bend at 806 cm⁻¹. The NMR and IR data confirm the metal-hydride insertion mechanism.

FIG. 8 depicts a solid state ¹H NMR spectrum revealing the disappearance of hydride resonances (4 ppm to 5 ppm) and the generation of formate resonances (8 to 10 ppm) following CO₂ dosing.

FIG. 9 is a plot of solid state ¹³C NMR spectra of ¹³CO₂-dosed ZnH-MFU-4l demonstrating the appearance of a labeled formate peak.

FIG. 10 is a plot of PXRD diffraction patterns of starting from ZnH-MFU-4l after the sample was previously activated under flowing He and then cooled to room temperature (bottom solid diffractogram), the same material was then exposed to flowing CO₂, heated to 300° C. (dashed diffractograms) and then cooled to 25° C. (middle solid diffractogram). Changes in peak intensities indicate changes in electron density corresponding to CO₂ adsorption. The gas was then switched to He and the same sample was heated to 300° C. (dashed diffractograms). Finally, the sample was cooled under He to 25° C. Changes in peak intensities upon heating indicate CO₂ is desorbed. The top diffractogram corresponds to the desorption product under He which corresponds to the diffraction pattern of the starting ZnH-MFU-4l material.

FIG. 11 is a depiction of the solid-state structure obtained from single-crystal X-ray diffraction of the framework Zn-CFA-1 with pentanuclear nodal cluster depicted for clarity.

FIG. 12A-12B is a synthetic procedure developed to exchange terminal capping acetate anions to chloride ligands and then to formate anions shown schematically. Carbon dioxide extrusion is accomplished through thermolysis at 280° C. under vacuum (10⁻⁶ bar), accompanied by conversion of Zn(OCHO)-CFA-1 to Zn-CFA-1 in quantitative yield.

### DETAILED DESCRIPTION

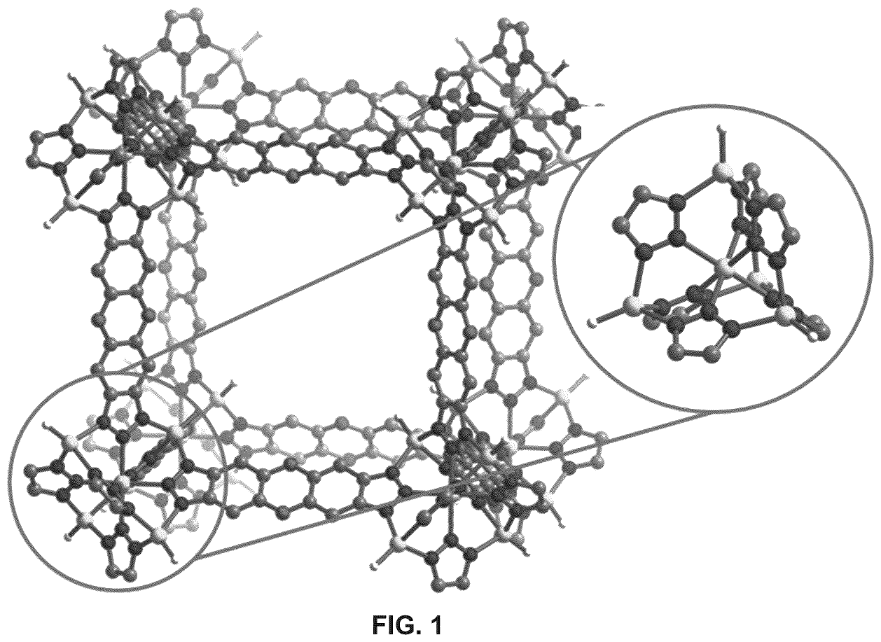

Referring more specifically to the drawings, for illustrative purposes, compositions, constructs and methods for high temperature acid gas separations are generally shown. Several embodiments of the technology are described generally in FIG. 1 to FIG. 12B to illustrate the characteristics and functionality of the compositions, systems, materials and methods. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

Metal-organic frameworks (MOFs) are a highly porous class of materials with discrete coordinatively unsaturated metal centers that have proven effective towards enabling highly selective metal-adsorbate interactions. The incorporation of open metal-hydride sites in the MOF platforms described herein enables the capture of acid gases such as CO₂ at some of the highest temperatures that have been reported in porous materials. Traditionally, porous frameworks known in the art either (1) rely on weak physical adsorption mechanisms that are nonspecific for CO₂ at elevated temperatures or (2) suffer material degradation upon thermolysis. Alcohol-amines remain the most commercially mature carbon capture technology, but alcohol amines undergo volatilization as well as irreversible degradation at elevated temperatures limiting their usefulness. While metal-oxide salts such as calcium oxide (CaO) or magnesium oxide (MgO) can capture CO₂ at elevated temperatures, the lack of permanent porosity and the propensity to sinter over repeated cycling induce slow adsorption kinetics and minimal cyclability.

Provided are two family groups of porous metal-organic framework materials for acid gas separations: M-X-MFU-4l and MH-CFA-1. The ZnH-MFU-4l materials are used to illustrate a larger group of materials comprising the metal-organic framework M-X-MFU-4l, where M=Zn, Mg, Ca, Mn, Fe, Co, Ni, Cu, Al, Cd and Zr including mixtures of these metals within the same framework, and X denotes an anionic terminal ligand such as hydride (H⁻), and MH-MFU-4l=M₅Hₓ(btdd)₃; H₂(btdd)=bis(1H-1,2,3-triazolo[4,5-b],[4′,5′-i])dibenzo[1,4]dioxin) and x=1-12 as illustrated in FIG. 1.

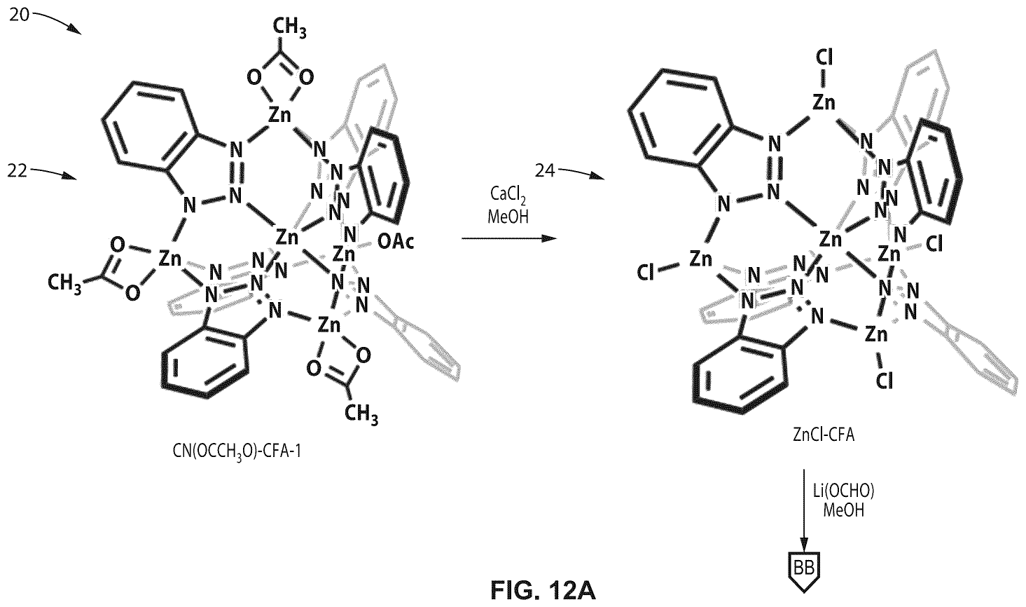

The ZnH-CFA-1 metal-organic framework is used to illustrate the group of frameworks M-X-CFA-1, where M=Zn, Mg, Ca, Mn, Fe, Co, Ni, Cu, Al, Cd and Zr including mixtures of these metals within the same framework, and X denotes an anionic terminal ligand such as hydride (H⁻) and MH-CFA-1=(M₅Hₓ(bibta)₃ where H₂(bibta)=1H,1′H-5,5′-bibenzo[d][1,2,3]triazole and x=1-12 as illustrated in FIG. 11.

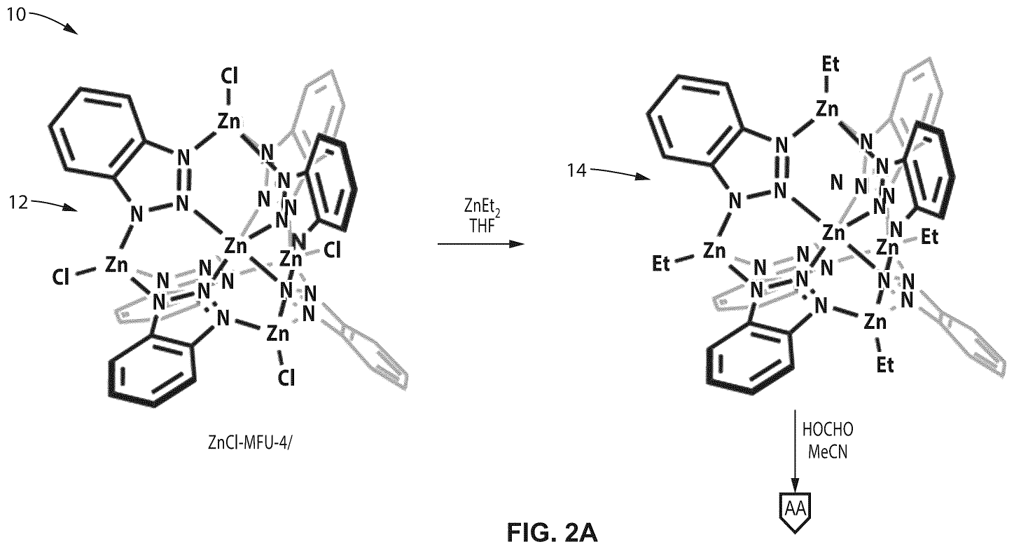

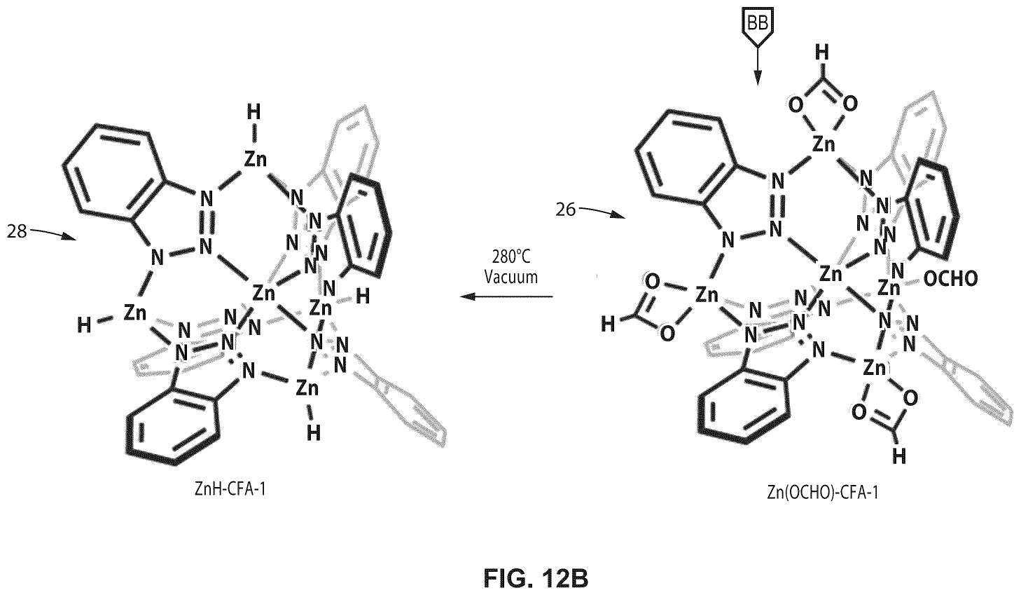

New synthetic procedures for the preparation of the M-X-MFU-4l and MH-CFA-1 frameworks are also provided as illustrated in FIG. 2 and FIG. 12A-12B respectively.

The metal-hydride sites contained within the MOFs yield materials that are (1) selective for CO₂ at effluent gas temperatures, (2) can be regenerated efficiently with pressure swing adsorption processes, and (3) offer the beneficial adsorption kinetics and cyclability of porous materials.

Turning now to FIG. 1, a crystal structure of the metal-organic framework ZnH-MFU-4l and the parent framework ZnCl-MFU-4l are shown schematically. A pentanuclear cluster node of the framework is depicted for clarity.

One embodiment of a synthetic procedure 10 for the M-X-MFU-4l framework is shown in FIG. 2A-2B. Generally, the procedure exchanges terminal capping chloride ligands for formate anions to produce the final product. The process optimizes the CO₂ capacity by activating ZnCl-MFU-4l 12. The starting ZnCl-MFU-4l (0.160 g) is treated with a diethylzinc solution (1 g, 15 wt % in toluene) and THF (3 mL) then heated at 50° C. for 12 hours. The resulting alkylated material 14 is washed with THF, diethyl ether, methanol, and finally suspended in acetonitrile (3 mL). Formic acid (0.100 mL) is then added to the suspension and the reaction is heated at 60° C. for 12 hours. The material 16 is then washed with additional acetonitrile, methanol, and benzene before the being heated at 280° C. under vacuum (10⁻⁶ bar) to form the final product 18. Carbon dioxide adsorption is accomplished through thermolysis at 280° C. under vacuum, accompanied by conversion of Zn(OCHO)-MFU-4l to ZnH-MFU-4l in quantitative yield.

These frameworks, illustrated with ZnH-MFU-4l, ZnH-CFA-1 and other metal-hydride containing porous materials, are suitable for capture of CO₂ from high temperature CO₂ containing streams such as steel or cement manufacturing effluents. The carbonated product, Zn(OCHO)-MFU-4l and Zn(OCHO)-CFA-1 demonstrate remarkable stability to ambient temperature water exposure. In one embodiment of the present technology, these metal-hydride frameworks are embedded in the catalyst bed of a water-gas shift reactor for adsorption enhancement of the water-gas shift reaction.

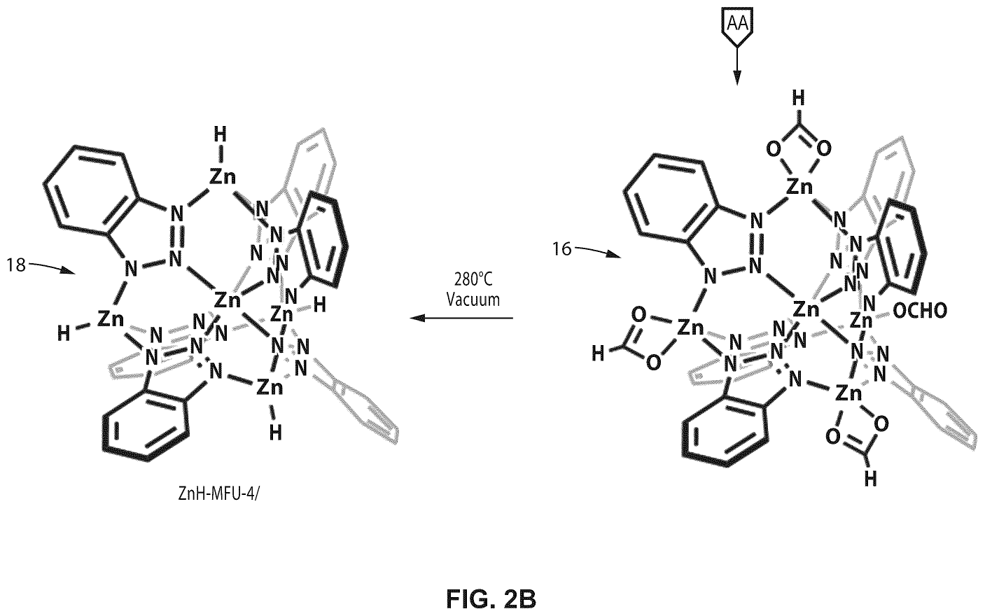

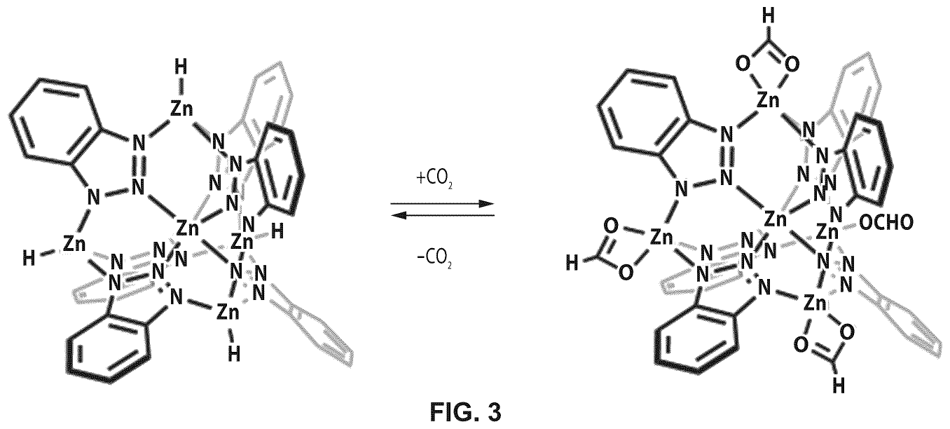

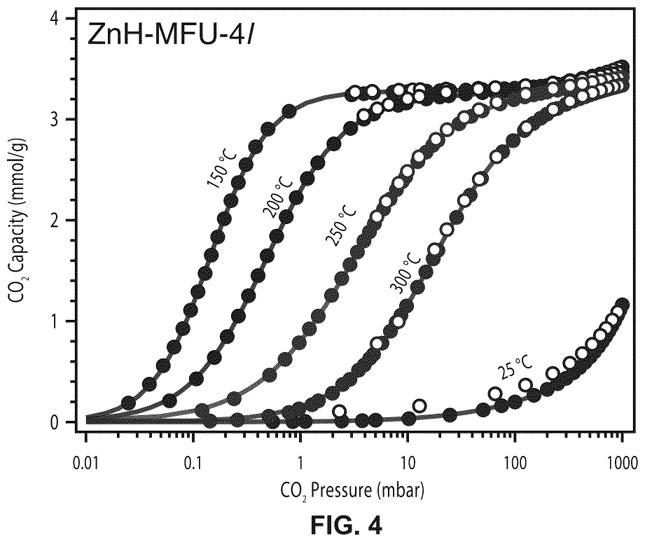

Gas adsorption of the ZnH-MFU-4l framework material is illustrated in FIG. 3 and the adsorption and desorption performance data shown in FIG. 4 and the data in FIG. 5A and FIG. 5B demonstrate the fast kinetics. Adsorption is rendered reversible at temperatures greater than 180° C. with a hysteresis-free desorption achieved upon pressure reduction with an applied vacuum.

The general functional mechanism is believed to be the insertion of CO₂ or other acid gas into a metal-hydride bond at elevated temperatures in a porous material. Insertion of CO₂ into the zinc-hydride bond in the peripheral sites of the pentanuclear cluster node in the cubic framework ZnH-MFU-4l (Zn₅H₄(btdd)₃; H₂btdd=bis(1H-1,2,3-triazolo[4,5-b],[4′,5′-i])dibenzo[1,4]dioxin)) and the new framework ZnH-CFA-1 (Zn₅H₄(bibta)₃ upon treatment with CO₂ at elevated temperatures is observed. This insertion results in the formation of formate-appended Zn(OCHO)-MFU-4l. Single component CO₂ adsorption isotherm measurements performed on ZnH-MFU-4l between 150° C. and 300° C., shown in FIG. 4A, reveal a steep CO₂ uptake at low partial pressures, indicating strong sorbent-interactions with the framework. Metal-hydride insertion enables CO₂ capture by the framework at higher temperatures than required for conventional porous materials.

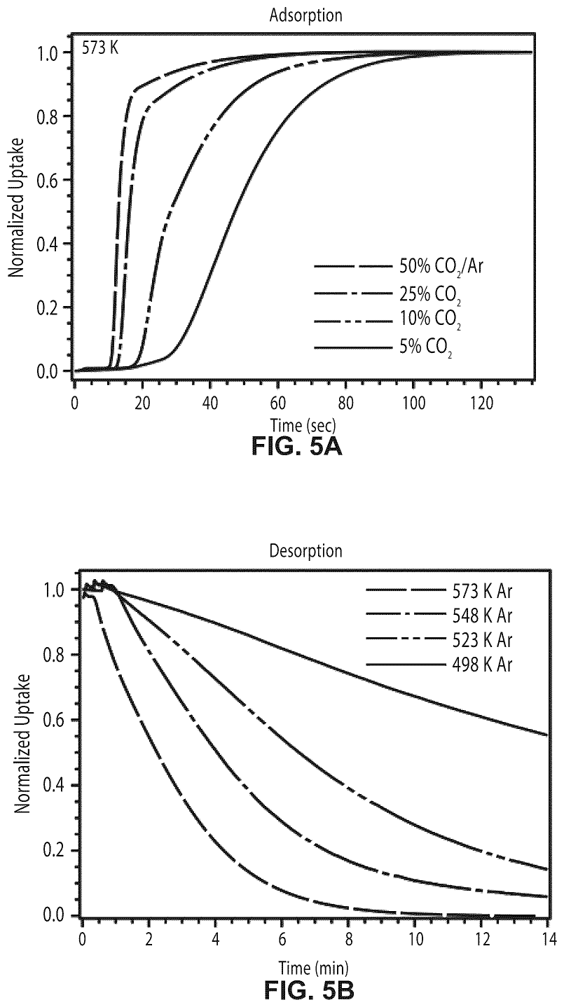

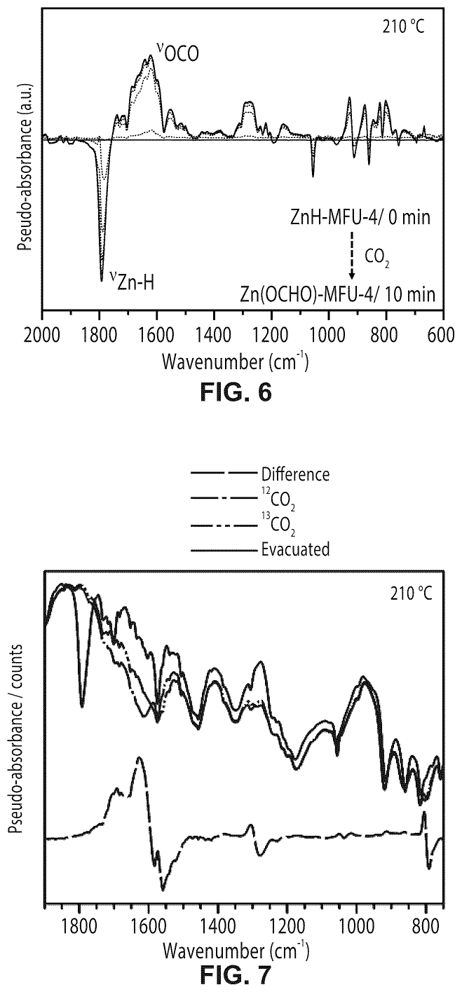

The metal-hydride insertion mechanism was confirmed through ¹H and ¹³C NMR spectroscopy and in situ dosed diffuse reflectance Fourier transform infrared spectroscopy (DRIFTS). The time-dependent infrared (IR) spectra of ZnH-MFU-4l upon dosing with 200 mbar of CO₂ at 210° C. is shown in FIG. 6. It can be observed that spectral changes ceased within five minutes following CO₂ dosing, demonstrating rapid saturation kinetics. Similarly, the IR spectra of ZnH-MFU-4l reacting with isotopically labeled ¹³CO₂ shown in FIG. 7 reveals characteristic formate stretches at 1613 cm⁻¹ and 1304 cm⁻¹ and a formate bend at 806 cm⁻¹ confirming gas insertion.

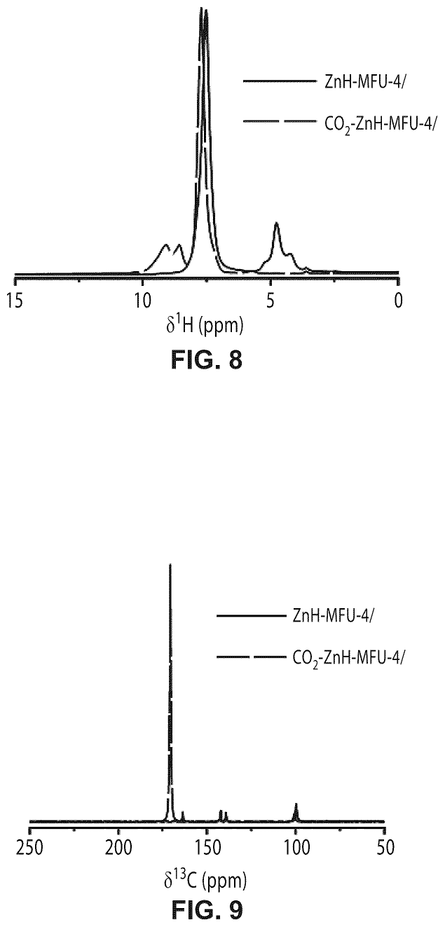

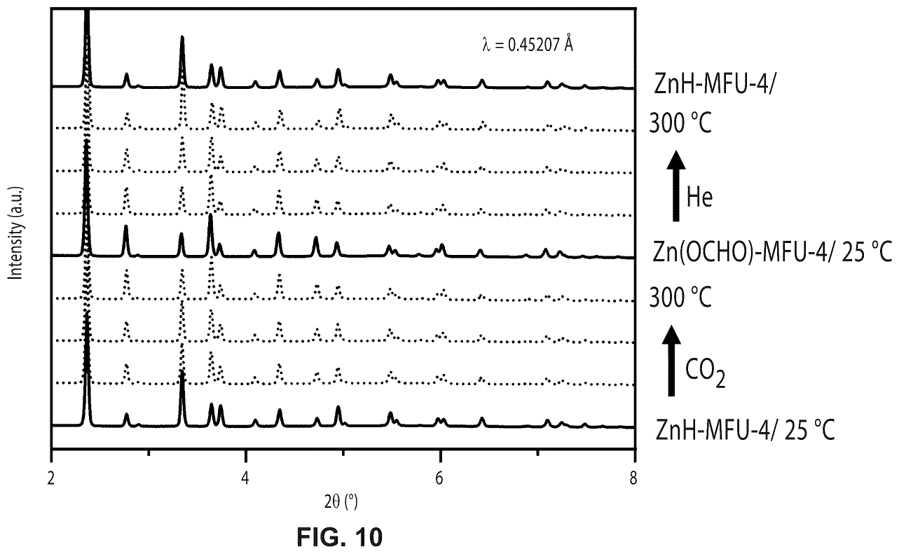

Acquired NMR data also confirmed the metal-hydride insertion mechanism. As seen in the solid state ¹H NMR spectrum of FIG. 8, hydride resonances (4-5 ppm) and the generation of formate resonances (8-10 ppm) disappear following CO₂ dosing. At the same time, the solid state ¹³C NMR spectra of ¹³CO₂-dosed ZnH-MFU-4l shown in FIG. 9 demonstrates the appearance of a labeled formate peak confirming insertion.

With both spectroscopic techniques, the addition of CO₂ at elevated temperatures decreases characteristic hydride features in each spectrum as signals corresponding to formate appear, indicating the formation of Zn(OCHO)-MFU-4l.

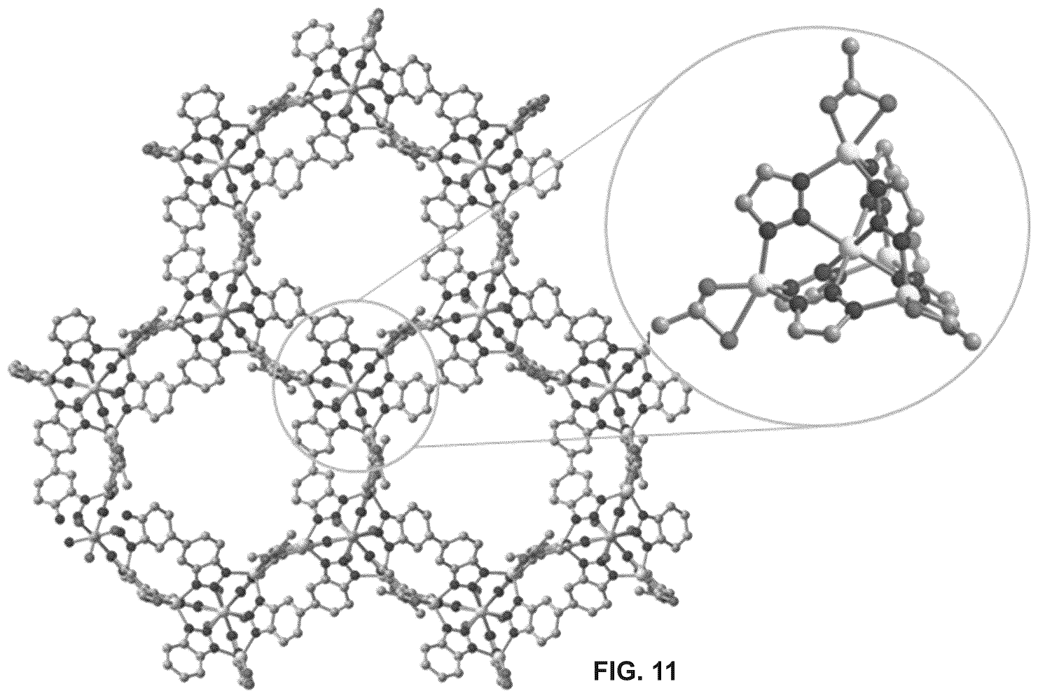

In situ powder X-ray diffraction techniques were also implemented to characterize a full adsorption and desorption cycle, wherein diffraction patterns recorded during cycles of heating and cooling under CO₂ followed by heating under the inert purge gas helium demonstrate both reversibility of the metal-hydride insertion mechanism and material robustness as shown in FIG. 10.

PXRD patterns of ZnH-MFU-4l during CO₂ adsorption cycling are shown in FIG. 10. The diffraction patterns of ZnH-MFU-4l of FIG. 10 were acquired as the sample was activated under flowing He gas, cooled to room temperature, exposed to CO₂, and then heated to 300° C. Changes in peak intensities indicate changes in electron density corresponding to CO₂ adsorption.

Diffraction patterns collected after cooling the same sample to room temperature under flowing CO₂, switching the He, and then heating to 300° C. are also shown in FIG. 10. Changes in peak intensities upon heating indicate CO₂ is desorbed from the framework. The top diffraction pattern corresponds to the desorption product under He which corresponds to the diffraction pattern of the starting ZnH-MFU-4l material.

Computations also support the experimental observation of a kinetic barrier to CO₂ insertion into the Zn—H metal-ligand bond. In accord, no conversion of ZnH-MFU-4l to Zn(OCHO)-MFU-4l is observed at room temperature upon air exposure, providing facile handing of ZnH-MFU-4l in which elevated temperatures pertinent to CO₂ capture are prerequisite for CO₂ capture and ZnH-MFU-4l conversion to occur. Importantly, the framework is stable to over 500 repeated CO₂ vacuum swing cycling experiments without major degradation, and the synthetic procedure has been optimized in which the improved material adsorbs 3.4 mmol/g of CO₂, further establishing ZnH-MFU-4l as a worthy material for implementation in numerous capture applications. The MOFs presented here are highly tunable, including selecting the effects of framework type, metal identity, oxidation state, and ligand field on the insertion of CO₂ insertion into metal-ligand bonds.

It can be seen that a number of porous material scaffolds can accommodate suitable metal-hydride sites for CO₂ separations at elevated temperatures including MOF platforms that contain or could be installed with terminal M-X sites (X═Cl, Br, I, OH, CF₃SO₃, OCH₃CO) with which exchange for hydride or formate ligands with disclosed synthetic procedures should be facile. These materials include additional porous materials such as the MOFs MCI-MFU-4 (MCI-MFU-4=M₅Cl₄(bbta)₃; H₂(bbta)=1H,5H-benzo(1,2-d:4,5-d)bistriazole); M=Zn, Fe, Cr, Co, Al, Cd, Mn, Ca, Zr and mixtures of these metals), MIL-101(M) (MIL-101(M)=M₃(μ₃-O)(OH)(H₂O)₂(bdc)₃; (bdc)²⁻=1,4-benzenedicarboxylate; M=Al, Ti, V, Cr, Fe, Sc, and Mn), MIL-53 (MIL-53=M(OH)(bdc); M=(Al, V, Cr, Fe, Co, Mn, Sc, Ni)), NU-2000 (NU-2000=Al(OH)(bodc) (bodc²⁻=bicyclo[2.2.2]octane-1,4-dicarboxylate), UiO-66 (UiO-66=Zr₆O₄(OH)₄(bdc)₆), UiO-67 (UiO-67=Zr₆O₄(OH)₄(bpdc)₆; (bpdc)²⁻=biphenyl-4-4′-dicarboxylate), UiO-67-bpy(M) (UiO-67-bpy(M)=Zr₆O₄(OH)(M)(X)₂(bpydc)₆; (bpydc)²⁻=2-2′-bipyridine-5-5′-dicarboxylate; M=Mn, Fe, Co, Ni, Cu, Zn; X═Cl, Br, I, CF₃SO₃, OCH₃CO), MOF-253 (MOF-253=Al(OH)(M)(X)₂ (bpydc)²⁻=Mn, Fe, Co, Ni, Cu, Zn; X═Cl, Br, I, CF₃SO₃, OCH₃CO), and PCN-224(M) (PCN-224=Zr₆(OH)₈(tcpp)₄; H₂tcpp=5,10,15-20-tetrakis(carboxyphenyl)porphyrin; M=Fe, Co, Ni, V).

A solid-state structure of an alternative embodiment of a metal-organic framework M-CFA-1, illustrated with Zn-CFA-1, is shown in FIG. 11. This structure was obtained from single-crystal X-ray diffraction of the framework Zn-CFA-1 with pentanuclear nodal cluster depicted for clarity. A new synthetic procedure was developed to exchange terminal capping acetate anions to chloride ligands and then to formate anions and is shown in FIG. 13A-13B. Carbon dioxide extrusion is accomplished through thermolysis at 280° C. under vacuum (10⁻⁶ bar), accompanied by conversion of Zn(OCHO)-CFA-1 to Zn-CFA-1 in quantitative yield.

In the embodiment shown in FIG. 11, the framework features metal-hydride sites, ZnH-CFA-1 (Zn₅Cl₄₋ₓHₓ(bibta)₃; H₂(bibta)=1H,1′H-5,5′-bibenzo[d][1,2,3]triazole) and has been shown to capture CO₂ at elevated temperatures demonstrating the generalizability of the metal-hydride insertion mechanism. Like the aforementioned ZnH-MFU-4l material illustrated in FIG. 1, single component CO₂ isotherms were conducted on the ZnH-CFA-1 material at 250° C. and demonstrate a high affinity for the adsorbate at low partial pressures.

The ZnH-CFA-1 framework was synthesized as shown schematically in FIG. 12A-12B. The fabrication process 20 begins by treating the Zn-CFA-1 framework 22 i.e. (Zn₅(OCCH₃O)₄(bibta)₃) (0.200 g, 1 equiv.) with a solution of CaCl₂) (0.546 g, 30 equiv.) in 20 mL of methanol and allowed to react for 24 hours. The mother liquor is decanted, and the powder resuspended in fresh CaCl₂ solution. After an additional 24 hours, the solution may be decanted and washed six times with methanol, and then the beige product 24 was suspended in solution of Li(OCHO)·H₂O (1.148 g, 100 equiv.) in 20 mL of methanol. The solvent was exchanged for fresh Li(OCHO)·H₂O solution after 24 hours. The resulting powder was subjected to a methanol Soxhlet extraction for 48 hours then dried under vacuum at 150° C. yielding a Zn(OCHO)-CFA-1) framework 26. Conversion to the ZnH-CFA-1 framework 28 was achieved via thermolysis by heating the resulting powder under a dynamic vacuum (10⁻⁶ bar) at 280° C.

These groups of metal-organic frameworks can be adapted to CO₂ capture at point sources from hot industrial reactions such as such as at steel and cement plants as well as from power-plant flue gases. The materials are expected to perform well in a packed bed columns which would allow for effluent gas flow. Some precautions for material stability and performance such as removal of fine particulate matter from cement effluent might be necessary before the CO₂ capture step, depending upon the application. The ZnH-MFU-4l, ZnH-CFA-1 and similar structures should be tolerant to humid CO₂ streams and therefore can be mixed into the catalyst bed in a water gas shift reactor to enhance hydrogen production via CO₂ capture through adsorption enhanced water gas shift at temperatures of approximately 200° C. Additionally, these metal-hydride sites may reversibly capture other acid gases including SO₂ and NO₂ which are released in significant quantities from a variety of industrial processes including in cement making.

In sum, metal-hydride sites contained within the MOFs yield materials that are (1) selective for CO₂ at effluent gas temperatures, (2) can be regenerated efficiently with pressure swing adsorption processes, and (3) offer the beneficial adsorption kinetics and cyclability of porous materials.

From the description herein, it will be appreciated that the present disclosure encompasses multiple implementations of the technology which include, but are not limited to, the following:

A composition, comprising a metal-organic framework M-X-MFU-4l, where M=Zn, Mg, Ca, Mn, Fe, Co, Ni, Cu, Al, Cd, Zr or mixtures of these metals within the same framework, and X denotes an anionic terminal ligand, and MH-MFU-4l=M₅Hₓ(btdd)₃; H₂(btdd)=bis(1H-1,2,3-triazolo[4,5-b],[4′,5′-i])dibenzo[1,4]dioxin) and x=1-12.

A composition, comprising a metal-organic framework M-X-CFA-1, where M=Zn, Mg, Ca, Mn, Fe, Co, Ni, Cu, Al, Cd, Zr or mixtures of these metals within the same framework, and X denotes an anionic terminal ligand such as hydride (H⁻) and MH-CFA-1=(M₅Hₓ(bibta)₃ where H₂(bibta)=1H,1′H-5,5′-bibenzo[d][1,2,3]triazole and x=1-12.

The composition of any preceding or following implementation, wherein the anionic terminal ligand is a hydride (H⁻).

The composition of any preceding or following implementation, the composition comprising a metal-organic framework ZnH-MFU-4l, (Zn₅H₄(btdd)₃ where H₂btdd=bis(1H-1,2,3-triazolo[4,5-b],[4′,5′-i])dibenzo[1,4]dioxin)).

The composition of any preceding or following implementation, the composition comprising a metal-organic framework ZnH-CFA-1 (Zn₅H₄(bibta)₃ where ZnH-CFA-1=Zn₅H₄(bibta)₃; H₂(bibta)=1H,1′H-5,5′-bibenzo[d][1,2,3]triazole.

A method of acid gas separation, the method comprising: (a) providing a mixture of gases for separation; and (b) adsorbing acid gases from the mixture of gases to a porous metal-organic framework (MOF) adsorbent, the framework comprising: a metal-organic framework M-X-MFU-4l, where M=Zn, Mg, Ca, Mn, Fe, Co, Ni, Cu, Al, Cd, Zr or mixtures of these metals within the same framework, and X denotes an anionic terminal ligand, and MH-MFU-4l=M₅Hₓ(btdd)₃; H₂(btdd)=bis(1H-1,2,3-triazolo[4,5-b],[4′,5′-i])dibenzo[1,4]dioxin) and x=1-12; or a metal-organic framework M-X-CFA-1, where M=Zn, Mg, Ca, Mn, Fe, Co, Ni, Cu, Al, Cd, Zr or mixtures of these metals within the same framework, and X denotes an anionic terminal ligand, and MH-CFA-1=(M₅Hₓ(bibta)₃ where H₂(bibta)=1H,1′H-5,5′-bibenzo[d][1,2,3]triazole and x=1-12.

The method of any preceding or following implementation, wherein the anionic terminal ligand is a hydride (H⁻).

The method of any preceding or following implementation, further comprising providing the mixture of gases for separation at temperatures between approximately 70° C. and approximately 370° C.

The method of any preceding or following implementation, further comprising separating residual gases with reduced acid gas concentrations; releasing the adsorbed acid gases from the framework; and collecting the released acid gases.

The method of any preceding or following implementation, wherein the adsorbed acid gases are released from the framework with a reduction in pressure.

The method of any preceding or following implementation, wherein the porous metal-organic framework (MOF) adsorbent comprises ZnH-MFU-4l (Zn₅H₄(btdd)₃ where H₂btdd=bis(1H-1,2,3-triazolo[4,5-b],[4′,5′-i])dibenzo[1,4]dioxin)).

The method of any preceding or following implementation, wherein the porous metal-organic framework (MOF) adsorbent comprises ZnH-CFA-1 (Zn₅H₄(bibta)₃ where ZnH-CFA-1=Zn₅H₄(bibta)₃; H₂(bibta)=1H,1′H-5,5′-bibenzo[d][1,2,3]triazole.

A method of enhancing a water-gas shift reaction process, the method comprising: mixing a metal hydride metal organic framework in a catalyst bed of a reactor; and capturing CO₂ produced by the water-gas shift reaction with the metal hydride metal organic framework.

The method of any preceding or following implementation, wherein the porous metal-organic framework comprises M-X-MFU-4l, where M=Zn, Mg, Ca, Mn, Fe, Co, Ni, Cu, Al, Cd, Zr or mixtures of these metals within the same framework, and X denotes an anionic terminal ligand, and MH-MFU-4l=M₅Hₓ(btdd)₃; H₂(btdd)=bis(1H-1,2,3-triazolo[4,5-b],[4′,5′-i])dibenzo[1,4]dioxin) and x=1-12.

The method of any preceding or following implementation, wherein the porous metal-organic framework comprises M-X-CFA-1, where M=Zn, Mg, Ca, Mn, Fe, Co, Ni, Cu, Al, Cd, Zr or mixtures of these metals within the same framework, and X denotes an anionic terminal ligand, and MH-CFA-1=(M₅Hₓ(bibta)₃ where H₂(bibta)=1H,1′H-5,5′-bibenzo[d][1,2,3]triazole and x=1-12.

A method of producing metal organic frameworks for high temperature acid gas separations, the method comprising: (a) providing a porous metal organic framework with open metal sites; (b) installing terminal M-X sites on the framework where (X═Cl, Br, I, OH, CF₃SO₃ or OCH₃CO) cap; and (c) exchanging a hydride or formate ligand for the cap of the terminal M-X sites on the framework.

The method of any preceding or following implementation, wherein the porous metal-organic framework is selected from the group consisting of MIL-101(M) (MIL-101(M)=M₃(μ₃-O)(OH)(H₂O)₂(bdc)₃; (bdc)²⁻=1,4-benzenedicarboxylate; M=Al, Ti, V, Cr, Fe, Sc, and Mn), MIL-53 (MIL-53=M(OH)(bdc); M=(Al, V, Cr, Fe, Co, Mn, Sc, Ni)), and NU-2000 (NU-2000=Al(OH)(bodc) (bodc²⁻=bicyclo[2.2.2]octane-1,4-dicarboxylate), UiO-66 (UiO-66=Zr₆O₄(OH)₄(bdc)₆).

The method of any preceding or following implementation, wherein the porous metal-organic framework is selected from the group consisting of UiO-66 (UiO-66=Zr₆O₄(OH)₄(bdc)₆), UiO-67 (UiO-67=Zr₆O₄(OH)₄(bpdc)₆; (bpdc)²⁻=biphenyl-44-dicarboxylate), and UiO-67-bpy(M) (UiO-67-bpy(M)=Zr₆O₄(OH)(M)(X)₂(bpydc)₆; (bpydc)²⁻=2-2′-bipyridine-5-5′-dicarboxylate; M=Mn, Fe, Co, Ni, Cu, Zn; X═Cl, Br, I, CF₃SO₃, OCH₃CO).

The method of any preceding or following implementation, wherein the porous metal-organic framework is selected from the group consisting of MOF-253 (MOF-253=Al(OH)(M)(X)₂ (bpydc)²⁻=Mn, Fe, Co, Ni, Cu, Zn; X═Cl, Br, I, CF₃SO₃, OCH₃CO), and PCN-224(M) (PCN-224=Zr₆(OH)₈(tcpp)₄; H₂tcpp=5,10,15-20-tetrakis(carboxyphenyl)porphyrin; M=Fe, Co, Ni, V).

The method of claim 16, further comprising: installing terminal M-X sites on the framework where (X=an acetate cap); substituting chloride ligands for the acetate caps; and exchanging a hydride or formate ligand for the chlorine ligands on the framework.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these group elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system or method.

As used herein, the term “set” refers to a collection of one or more objects. Thus, for example, a set of objects can include a single object or multiple objects.

Relational terms such as first and second, top and bottom, upper and lower, left and right, and the like may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element.

As used herein, the terms “approximately”, “approximate”, “substantially”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to +5%, less than or equal to +4%, less than or equal to +3%, less than or equal to ±2%, less than or equal to ±1%, less than or equal to ±0.5%, less than or equal to +0.1%, or less than or equal to ±0.05%. For example, “substantially” aligned can refer to a range of angular variation of less than or equal to +10°, such as less than or equal to 5°, less than or equal to 4°, less than or equal to 3°, less than or equal to 2°, less than or equal to 1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential features or elements of the technology describes herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after that application is filed. Accordingly the reader should consult the application as filed for the original content of the disclosure. Any deletion of content of the disclosure should not be construed as a disclaimer, forfeiture or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A composition, comprising:
a metal-organic framework M-X-MFU-4l, where M=Zn, Mg, Ca, Mn, Fe, Co, Ni, Cu, Al, Cd, Zr or mixtures of these metals within the same framework, and X denotes an anionic terminal ligand, and MH-MFU-4l=M₅Hₓ(btdd)₃; H₂(btdd)=bis(1H-1,2,3-triazolo[4,5-b],[4′,5′-i])dibenzo[1,4]dioxin) and x=1-12.

2. The composition of claim 1, wherein said anionic terminal ligand is a hydride (H⁻).

3. The composition of claim 1, said composition comprising:
a metal-organic framework ZnH-MFU-4l, (Zn₅H₄(btdd)₃ where H₂btdd=bis(1H-1,2,3-triazolo[4,5-b],[4′,5′-i])dibenzo[1,4]dioxin)).

4. A composition, comprising:
a metal-organic framework M-X-CFA-1, where M=Zn, Mg, Ca, Mn, Fe, Co, Ni, Cu, Al, Cd, Zr or mixtures of these metals within the same framework, and X denotes an anionic terminal ligand such as hydride (H⁻) and MH-CFA-1=(M₅Hₓ(bibta)₃ where H₂(bibta)=1H,1′H-5,5′-bibenzo[d][1,2,3]triazole and x=1-12.

5. The composition of claim 4, wherein said anionic terminal ligand is a hydride (H⁻).

6. The composition of claim 4, said composition comprising:
a metal-organic framework ZnH-CFA-1 (Zn₅H₄(bibta)₃ where ZnH-CFA-1=Zn₅H₄(bibta)₃; H₂(bibta)=1H,1′H-5,5′-bibenzo[d][1,2,3]triazole.

7. A method of acid gas separation, the method comprising:
(a) providing a mixture of gases for separation; and
(b) adsorbing acid gases from the mixture of gases to a porous metal-organic framework (MOF) adsorbent, the framework comprising:
a metal-organic framework M-X-MFU-4l, where M=Zn, Mg, Ca, Mn, Fe, Co, Ni, Cu, Al, Cd, Zr or mixtures of these metals within the same framework, and X denotes an anionic terminal ligand, and MH-MFU-4l=M₅Hₓ(btdd)₃; H₂(btdd)=bis(1H-1,2,3-triazolo[4,5-b],[4′,5′-i])dibenzo[1,4]dioxin) and x=1-12; or
a metal-organic framework M-X-CFA-1, where M=Zn, Mg, Ca, Mn, Fe, Co, Ni, Cu, Al, Cd, Zr or mixtures of these metals within the same framework, and X denotes an anionic terminal ligand, and MH-CFA-1=(M₅Hₓ(bibta)₃ where H₂(bibta)=1H,1′H-5,5′-bibenzo[d][1,2,3]triazole and x=1-12.

8. The method of claim 7, wherein said anionic terminal ligand is a hydride (H⁻).

9. The method of claim 7, further comprising:
providing said mixture of gases for separation at temperatures between approximately 70° C. and approximately 370° C.

10. The method of claim 7, further comprising:
separating residual gases with reduced acid gas concentrations;
releasing the adsorbed acid gases from the framework; and
collecting the released acid gases.

11. The method of claim 10, wherein said adsorbed acid gases are released from the framework with a reduction in pressure.

12. The method of claim 7, wherein said porous metal-organic framework (MOF) adsorbent comprises ZnH-MFU-4l (Zn₅H₄(btdd)₃ where H₂btdd=bis(1H-1,2,3-triazolo[4,5-b],[4′,5′-i])dibenzo[1,4]dioxin)).

13. The method of claim 7, wherein said porous metal-organic framework (MOF) adsorbent comprises ZnH-CFA-1 (Zn₅H₄(bibta)₃ where ZnH-CFA-1=Zn₅H₄(bibta)₃; H₂(bibta)=1H,1′H-5,5′-bibenzo[d][1,2,3]triazole.

14. A method of enhancing a water-gas shift reaction process, the method comprising:
mixing a metal hydride metal organic framework in a catalyst bed of a reactor; and
capturing CO₂ produced by the water-gas shift reaction with the metal hydride metal organic framework.

15. The method of claim 14, wherein said porous metal-organic framework comprises M-X-MFU-4l, where M=Zn, Mg, Ca, Mn, Fe, Co, Ni, Cu, Al, Cd, Zr or mixtures of these metals within the same framework, and X denotes an anionic terminal ligand, and MH-MFU-4l=M₅Hₓ(btdd)₃; H₂(btdd)=bis(1H-1,2,3-triazolo[4,5-b],[4′,5′-i])dibenzo[1,4]dioxin) and x=1-12.

16. The method of claim 14, wherein said porous metal-organic framework comprises M-X-CFA-1, where M=Zn, Mg, Ca, Mn, Fe, Co, Ni, Cu, Al, Cd, Zr or mixtures of these metals within the same framework, and X denotes an anionic terminal ligand, and MH-CFA-1=(M₅Hₓ(bibta)₃ where H₂(bibta)=1H,1′H-5,5′-bibenzo[d][1,2,3]triazole and x=1-12.

17. A method of producing metal organic frameworks for high temperature acid gas separations, the method comprising:
(a) providing a porous metal organic framework with open metal sites;
(b) installing terminal M-X sites on the framework where (X═Cl, Br, I, OH, CF₃SO₃ or OCH₃CO) cap; and
(c) exchanging a hydride or formate ligand for said cap of the terminal M-X sites on the framework.

18. The method of claim 17, wherein said porous metal-organic framework is selected from the group consisting of MIL-101(M) (MIL-101(M)=M₃(μ₃-O)(OH)(H₂O)₂(bdc)₃; (bdc)²⁻=1,4-benzenedicarboxylate; M=Al, Ti, V, Cr, Fe, Sc, and Mn), MIL-53 (MIL-53=M(OH)(bdc); M=(Al, V, Cr, Fe, Co, Mn, Sc, Ni)), and NU-2000 (NU-2000=Al(OH)(bodc) (bodc²⁻=bicyclo[2.2.2]octane-1,4-dicarboxylate), UIO-66 (UiO-66=Zr₆O₄(OH)₄(bdc)₆).

19. The method of claim 17, wherein said porous metal-organic framework is selected from the group consisting of UiO-66 (UiO-66=Zr₆O₄(OH)₄(bdc)₆), UiO-67 (UiO-67=Zr₆O₄(OH)₄(bpdc)₆; (bpdc)²⁻=biphenyl-44-dicarboxylate), and UiO-67-bpy(M) (UiO-67-bpy(M)=Zr₆O₄(OH)(M)(X)₂(bpydc)₆; (bpydc)²=2-2′-bipyridine-5-5′-dicarboxylate; M=Mn, Fe, Co, Ni, Cu, Zn; X═Cl, Br, I, CF₃SO₃, OCH₃CO).

20. The method of claim 17, wherein said porous metal-organic framework is selected from the group consisting of MOF-253 (MOF-253=Al(OH)(M)(X)₂ (bpydc)²⁻=Mn, Fe, Co, Ni, Cu, Zn; X═Cl, Br, I, CF₃SO₃, OCH₃CO), and PCN-224(M) (PCN-224=Zr₆(OH)₃(tcpp)₄; H₂tcpp=5,10,15-20-tetrakis(carboxyphenyl)porphyrin; M=Fe, Co, Ni, V).

21. The method of claim 17, further comprising:
installing terminal M-X sites on the framework where (X=an acetate cap);
substituting chloride ligands for said acetate caps; and
exchanging a hydride or formate ligand for said chlorine ligands on the framework.
